(19) United States
(12) Patent Application Publication
(10) Pub. No.: US 2020/0033871 A1
(43) Pub. Date: Jan. 30, 2020

(54) VEHICLE CONTROL DEVICE

(71) Applicant: HONDA MOTOR CO., LTD., MINATO-KU, TOKYO (JP)

(72) Inventor: Daichi KATO, WAKO-SHI, SAITAMA-KEN (JP)

(21) Appl. No.: 16/337,048

(22) PCT Filed: Sep. 1, 2017
(86) PCT No.: PCT/JP2017/031553

§ 371 Date: Mar. 27, 2019

(30) Foreign Application Priority Data
Sep. 29, 2016 (JP) 2016-190519

(51) Int. Cl. G05D 1/02

(52) U.S. Cl. CPC G05D 1/0223; G05D 1/0214

(57) ABSTRACT

A vehicle control device according to the present invention is provided with: a connection point setting unit that sets a connection point between a start point and an end point of a point sequence which indicates at least a part of positions of a travel trajectory; and an interpolation processing unit that specifies the position of the travel trajectory by interpolating a section from a trajectory starting point of the travel trajectory to the connection point by using a clothoid curve satisfying a boundary condition concerning the trajectory starting point and the connection point.

### TECHNICAL FIELD

The present invention relates to a vehicle control device that successively generates a travel trajectory for a vehicle and controls the vehicle based on the travel trajectory.

### BACKGROUND ART

Conventional vehicle control devices that successively generate a travel trajectory for a vehicle and control the vehicle based on the travel trajectory are known. For example, various techniques have been developed for generating a travel trajectory in consideration of the continuity of curvature and the continuity of curvature change rate (hereinafter, referred to as “smoothness of trajectory”) have been developed.

Japanese Laid-Open Patent Publication No. 2010-073080 (paragraphs [0032] to [0037], for instance) proposes a method of generating a vehicle travel trajectory with introduction of switchback points where necessary such that an input constraint condition is satisfied and the value of a cost function containing an element on the magnitude or change rate of a curve is minimized. Specifically, it is described that each interpolation point between an entry point (trajectory beginning point) and an exit point (trajectory end point) is interpolated by a B-spline curve.

### SUMMARY OF INVENTION

However, the method according to Japanese Laid-Open Patent Publication No. 2010-073080 is intended for one-time generation of a travel trajectory and does not consider situations where the trajectory beginning and end points change momentarily. For example, if a calculation process to determine whether the switchback point is needed and specify the position thereof is added, it takes much calculation time to acquire the travel trajectory. Thus, the real-time property is lost because of this time. In addition, if the vehicle deviates from the travel trajectory, the discontinuity of the travel trajectories generated in a time series occurs. Thus, it becomes difficult to secure the continuity of the curvature and the continuity of the rate of change of the curvature.

The present invention has been made in order to solve the above problem and an object is to provide a vehicle control device that can secure the smoothness of a trajectory around a trajectory beginning point while a calculation time of an interpolation process is reduced.

A vehicle control device according to a present invention is a device configured to successively generate a travel trajectory of a vehicle and control the vehicle on a basis of the travel trajectory, the vehicle control device including: a connection point setting unit configured to set a connection point that exists between a start point and an end point of a point sequence expressing a position of at least a part of the travel trajectory; and an interpolation process unit configured to specify the position of the travel trajectory by interpolating a section from a trajectory beginning point of the travel trajectory to the connection point that is set by the connection point setting unit by a clothoid curve that satisfies a border condition regarding the trajectory beginning point and the connection point.

In this manner, the section from the trajectory beginning point of the travel trajectory to the connection point that is set is interpolated by the clothoid curve that satisfies the border condition regarding the trajectory beginning point and the connection point. Thus, the entire section of the trajectory that includes the trajectory beginning point and the connection point becomes smooth regardless of the shape of an interpolation curve in a section from the connection point to the end point of the point sequence. Therefore, the smoothness of the trajectory around the trajectory beginning point can be secured while a calculation time of an interpolation process is reduced.

In addition, the interpolation process unit may be configured to interpolate a section from the connection point to the end point by a polynomial expression interpolation curve. The calculation time of the interpolation process can be further reduced by interpolating a section where the smoothness of the trajectory can be easily secured (section from the connection point to the end point) by the polynomial expression interpolation curve whose calculation time is less than that of the clothoid curve.

Moreover, the vehicle control device may further include: a primary evaluation unit configured to perform a primary evaluation for a candidate group of the travel trajectory; and a secondary evaluation unit configured to perform a secondary evaluation for a part of the candidate group of the travel trajectory for which the primary evaluation has been performed by the primary evaluation unit, wherein: the primary evaluation unit may be configured to perform the primary evaluation for each travel trajectory in which the section from the trajectory beginning point to the connection point is interpolated by the polynomial expression interpolation curve; and the secondary evaluation unit may be configured to perform the secondary evaluation for each travel trajectory in which the section from the trajectory beginning point to the connection point is interpolated by the clothoid curve. Therefore, the execution of the interpolation process by the clothoid curve for the candidates that are excluded in the primary evaluation can be omitted. Thus, the calculation time to generate each travel trajectory can be drastically reduced.

Furthermore, the secondary evaluation unit may be configured to perform the secondary evaluation in which at least one of calculation quantity, a calculation time, and number of items is different from that of the primary evaluation. For example, the primary evaluation unit may be configured to perform the primary evaluation that does not include an evaluation item regarding smoothness of the trajectory around the trajectory beginning point, and the secondary evaluation unit may be configured to perform the secondary evaluation that includes the evaluation item regarding the smoothness of the trajectory around the trajectory beginning point. The calculation time to evaluate each travel trajectory can be drastically reduced by omitting the evaluation of the smoothness of the trajectory for the tentative candidates (primary evaluation) and performing the evaluation of the smoothness of the trajectory for the final candidates (secondary evaluation).

By the vehicle control device according to the present invention, the smoothness of the trajectory around the trajectory beginning point can be secured while the calculation time of the interpolation process is reduced.

### BRIEF DESCRIPTION OF DRAWINGS

FIG. 1 is a block diagram that illustrates a configuration of a vehicle control device according to an embodiment of the present invention;

FIG. 2 is a function block diagram of a middle-term trajectory generation unit illustrated in FIG. 1;

FIG. 3 is a function block diagram of a primary selection unit illustrated in FIG. 2;

FIG. 4 is a first schematic diagram that illustrates a positional relation between a vehicle on a virtual space and a point sequence that specifies a trajectory candidate;

FIG. 5 is a second schematic diagram that illustrates a positional relation between the vehicle on the virtual space and the point sequence that specifies the trajectory candidate;

FIG. 6 is a function block diagram of a secondary selection unit illustrated in FIG. 2;

FIG. 7 is a flowchart that is used to describe an operation regarding the function block diagram in FIG. 6;

FIG. 8 is a diagram that illustrates a setting result of a connection point in step S2 in FIG. 7;

FIG. 9 is a diagram that shows the position dependency of a curvature and a rate of change of the curvature in a triple clothoid curve;

FIG. 10 is a diagram that illustrates a result of performing affine transformation for the triple clothoid curve;

FIG. 11 is a diagram that illustrates a decision result of an output trajectory in step S7 in FIG. 7; and

FIG. 12 is a diagram that illustrates the decision result of the output trajectory in a case where a start point and a trajectory beginning point of the point sequence are different.

### DESCRIPTION OF EMBODIMENT

The vehicle control device according to the present invention is described below by showing preferred embodiments with reference to the accompanying drawings.

### [Configuration of Vehicle Control Device 10]

### <Overall Configuration>

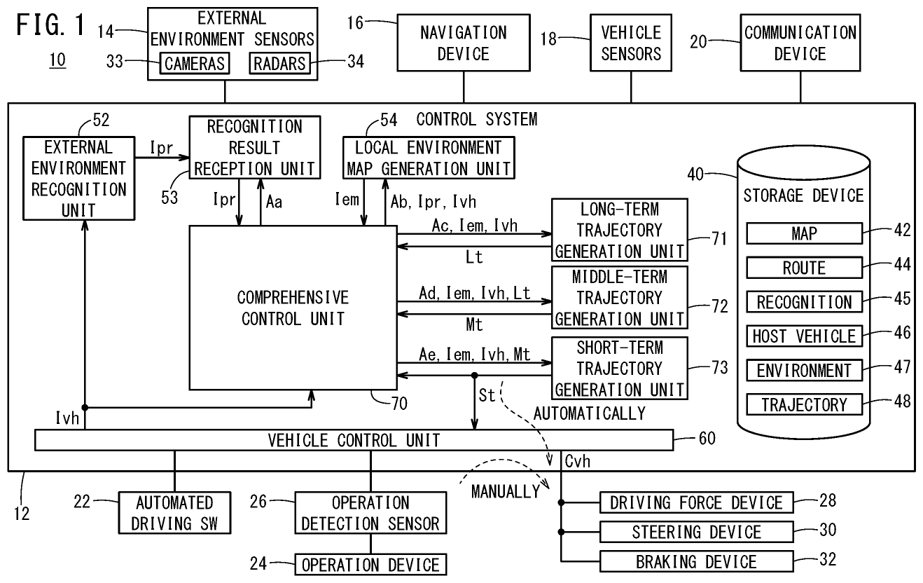

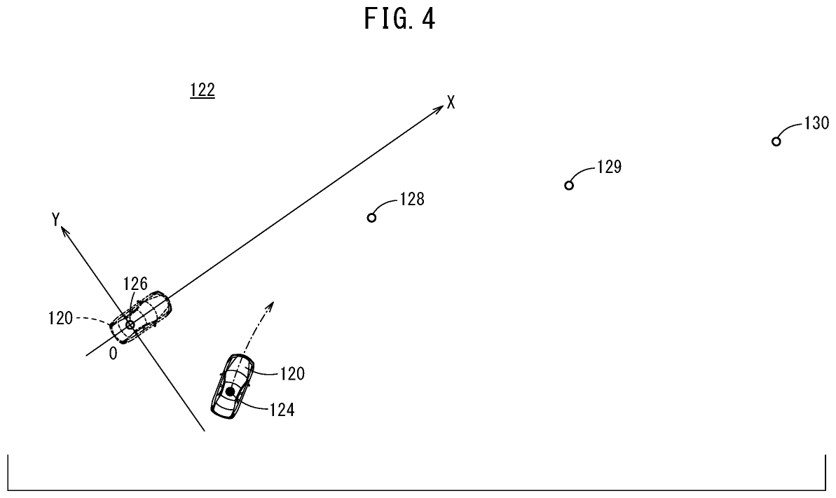

FIG. 1 is a block diagram that illustrates a configuration of a vehicle control device 10 according to one embodiment of the present invention. The vehicle control device 10 is incorporated into a vehicle 120 (FIG. 4), and can perform automated driving or automated driving assistance of the vehicle 120. The vehicle control device 10 includes a control system 12, an input device, and an output device. Each of the input device and the output device is connected to the control system 12 through a communication line.

The input device includes external environment sensors 14, a navigation device 16, vehicle sensors 18, a communication device 20, an automated driving switch 22, and an operation detection sensor 26 that is connected to an operation device 24.

The output device includes a driving force device 28 to drive wheels that are not shown, a steering device 30 to steer the wheels, and a braking device 32 to brake the wheels.

### <Specific Configuration of Input Device>

The external environment sensors 14 include a plurality of cameras 33 and a plurality of radars 34 that acquire information expressing an external environment state of the vehicle 120 (hereinafter, external environment information), and outputs the acquired external environment information to the control system 12. The external environment sensors 14 may further include a plurality of LIDAR (Light Detection and Ranging, Laser Imaging Detection and Ranging) devices.

The navigation device 16 includes a satellite positioning device that can detect the current position of the vehicle 120, and user interfaces (for example, a touch panel display, a speaker, and a microphone). The navigation device 16 calculates a route to a designated destination on the basis of the current position of the vehicle 120 or a position designated by a user, and outputs the calculated route to the control system 12. The route calculated by the navigation device 16 is stored in a route information storage unit 44 of a storage device 40 as route information.

The vehicle sensors 18 include a speed sensor that detects the speed (the vehicle speed) of the vehicle 120, an acceleration sensor that detects an acceleration, a lateral acceleration sensor that detects a lateral acceleration, a yaw rate sensor that detects an angular velocity around a vertical axis, an orientation sensor that detects orientation or direction, and an inclination sensor that detects an inclination, and outputs a detection signal from each sensor to the control system 12. These detection signals are stored in a host vehicle state information storage unit 46 of the storage device 40 as host vehicle state information Ivh.

The communication device 20 is configured so as to communicate with external devices including a roadside machine, other vehicles, and servers. For example, the communication device 20 transmits and receives information regarding traffic equipment, information regarding the other vehicles, probe information, or the latest map information. Note that the map information is stored in the navigation device 16 and also stored as the map information in a map information storage unit 42 of the storage device 40.

The operation device 24 includes an accelerator pedal, a steering wheel (a car steering wheel), a brake pedal, a shift lever, and a direction indicating lever. The operation device 24 is provided with the operation detection sensor 26 that detects whether a driver's operation is performed, the operation amount, or an operation position.

The operation detection sensor 26 outputs to a vehicle control unit 60, the accelerator stepping amount (accelerator opening), the amount of steering wheel operation (steering amount), the brake stepping amount, a shift position, a right/left turning direction, or the like as detection results.

For example, the automated driving switch 22 is a push button switch provided on an instrument panel, and allows the user including the driver to switch manually between a non-automated driving mode (manual driving mode) and an automated driving mode.

In this embodiment, the automated driving mode and the non-automated driving mode are switched each time the automated driving switch 22 is pushed. Alternatively, to surely confirm driver's intention to perform the automated driving, for example, the non-automated driving mode can be switched to the automated driving mode when the automated driving switch 22 is pushed twice, and the automated driving mode can be switched to the non-automated driving mode when the automated driving switch 22 is pushed once.

The automated driving mode is a driving mode in which the vehicle 120 travels under control by the control system 12 in a state where the driver does not operate the operation device 24 (specifically, the accelerator pedal, the steering wheel, and the brake pedal). In other words, the automated driving mode is a driving mode in which the control system 12 controls the driving force device 28, the steering device 30, and the braking device 32 partially or entirely on the basis of an action plan (in a short term, a short-term trajectory St which will be described below) that is decided successively.

Note that in the automated driving mode, if the driver starts to operate the operation device 24, the automated driving mode is cancelled automatically and switched to the non-automated driving mode (manual driving mode).

### <Specific Configuration of Output Device>

The driving force device 28 is configured by a driving force ECU (Electronic Control Unit) and a driving source including an engine and/or traction motor. The driving force device 28 generates travel driving force (torque) by which the vehicle 120 travels in accordance with a vehicle control value Cvh that is input from the vehicle control unit 60, and transmits the travel driving force to the wheels directly or through a transmission.

The steering device 30 includes an EPS (electric power steering system) ECU and an EPS device. The steering device 30 changes the direction of the wheels (drive wheels) in accordance with the vehicle control value Cvh that is input from the vehicle control unit 60.

For example, the braking device 32 is an electric servo brake that is used in combination with a hydraulic brake, and includes a brake ECU and a brake actuator. The braking device 32 brakes the wheels in accordance with the vehicle control value Cvh that is input from the vehicle control unit 60.

### <Configuration of Control System 12>

The control system 12 is configured by one or a plurality of ECUs, and includes the storage device 40 or the like, in addition to various function achievement units. Note that, in this embodiment, the function achievement unit is a software function unit in which a function is achieved when a CPU (central processing unit) executes programs stored in the storage device 40. However, the function achievement unit can be achieved by a hardware function unit including an integrated circuit or the like.

The control system 12 includes, in addition to the storage device 40 and the vehicle control unit 60, an external environment recognition unit 52, a recognition result reception unit 53, a local environment map generation unit 54, a comprehensive control unit 70, a long-term trajectory generation unit 71, a middle-term trajectory generation unit 72, and a short-term trajectory generation unit 73. Here, the comprehensive control unit 70 controls synchronization of tasks among the recognition result reception unit 53, the local environment map generation unit 54, the long-term trajectory generation unit 71, the middle-term trajectory generation unit 72, and the short-term trajectory generation unit 73 so as to generally control each part.

The external environment recognition unit 52 refers to the host vehicle state information Ivh from the vehicle control unit 60, recognizes lane marks (while lines) on both sides of the vehicle 120 on the basis of the external environment information (including image information) from the external environment sensors 14, and generates “static” external environment information including a distance to a stop line and a travel possible area. In addition, the external environment recognition unit 52 generates “dynamic” external environment recognition information such as on obstacles (including parked or stopped vehicles), traffic participants (persons, and other vehicles), and the colors of a traffic light {blue (green), yellow (orange), red} on the basis of the external environment information from the external environment sensors 14.

The external environment recognition unit 52 outputs (transmits) to the recognition result reception unit 53, the generated static and dynamic external environment recognition information (hereinafter, also referred to as “external environment recognition information Ipr” collectively). In addition to this, the external environment recognition information Ipr is stored in an external environment recognition information storage unit 45 of the storage device 40.

In response to a calculation instruction Aa, the recognition result reception unit 53 outputs to the comprehensive control unit 70, the external environment recognition information Ipr received within a predetermined calculation cycle Toc (reference cycle or reference calculation cycle) together with a counter value of an update counter. Here, the calculation cycle Toc is the reference calculation cycle in the control system 12, and is set to a value of about several tens of milliseconds (ms), for example.

In response to a calculation instruction Ab from the comprehensive control unit 70, the local environment map generation unit 54 refers to the host vehicle state information Ivh and the external environment recognition information Ipr, generates local environment map information Iem within the calculation cycle Toc, and outputs to the comprehensive control unit 70, the local environment map information Iem together with the counter value of the update counter. That is to say, when the control is started, it takes the calculation cycle Toc×2 before the local environment map information Iem is generated.

Schematically, the local environment map information Iem is information in which the host vehicle state information Ivh is combined with the external environment recognition information Ipr. The local environment map information Iem is stored in a local environment map information storage unit 47 of the storage device 40.

In response to a calculation instruction Ac from the comprehensive control unit 70, the long-term trajectory generation unit 71 refers to the local environment map information Iem (only static component of external environment recognition information Ipr is used), the host vehicle state information Ivh, and a road map stored in the map information storage unit 42 (curvature of curve or the like), and generates a long-term trajectory Lt in the relatively longest calculation cycle (for example, 9×Toc). Then, the long-term trajectory generation unit 71 outputs to the comprehensive control unit 70, the generated long-term trajectory Lt together with the counter value of the update counter. Note that the long-term trajectory Lt is stored as trajectory information in a trajectory information storage unit 48 of the storage device 40.

In response to a calculation instruction Ad from the comprehensive control unit 70, the middle-term trajectory generation unit 72 refers to the local environment map information Iem (both dynamic and static components of external environment recognition information Ipr are used), the host vehicle state information Ivh, and the long-term trajectory Lt, and generates a middle-term trajectory Mt in a relatively middle calculation cycle (for example, 3×Toc). Then, the middle-term trajectory generation unit 72 outputs to the comprehensive control unit 70, the generated middle-term trajectory Mt together with the counter value of the update counter. Note that the middle-term trajectory Mt is stored in the trajectory information storage unit 48 as the trajectory information similarly to the long-term trajectory Lt.

In response to a calculation instruction Ae from the comprehensive control unit 70, the short-term trajectory generation unit 73 refers to the local environment map information Iem (both dynamic and static components of external environment recognition information Ipr are used), the host vehicle state information Ivh, and the middle-term trajectory Mt, and generates the short-term trajectory St in the relatively shortest calculation cycle (for example, Toc). Then, the short-term trajectory generation unit 73 simultaneously outputs to the comprehensive control unit 70 and the vehicle control unit 60, the generated short-term trajectory St together with the counter value of the update counter. Note that the short-term trajectory St is stored in the trajectory information storage unit 48 as the trajectory information similarly to the long-term trajectory Lt and the middle-term trajectory Mt.

Note that the long-term trajectory Lt indicates a trajectory in a travel time of about 10 seconds, for example, and is a trajectory in which the ride quality and the comfortability are prioritized. The short-term trajectory St indicates a trajectory in a travel time of about one second, for example, and is a trajectory in which it is prioritized to achieve vehicle dynamics and ensure safety. The middle-term trajectory Mt indicates a trajectory in a travel time of about five seconds, for example, and is an intermediate trajectory between the long-term trajectory Lt and the short-term trajectory St.

The short-term trajectory St corresponds to a data set that expresses target behavior of the vehicle 120 in each short cycle Ts (=Toc). The short-term trajectory St is a trajectory point sequence (x, y, θz, Vs, Va, κ, κ′, γ, δst) in which data units are, for example, a position x in a longitudinal direction (X-axis), a position y in a lateral direction (Y-axis), an attitude angle θz, speed Vs, acceleration Va, curvature κ, a rate of change of the curvature κ′, a yaw rate γ, and steering angle δst. The long-term trajectory Lt or the middle-term trajectory Mt, which has a different cycle, is a data set that is defined similarly to the short-term trajectory St.

The vehicle control unit 60 decides the vehicle control value Cvh that enables the vehicle 120 to travel in accordance with the behavior specified by the short-term trajectory St (trajectory point sequence), and outputs the acquired vehicle control value Cvh to the driving force device 28, the steering device 30, and the braking device 32.

### [Configuration and Operation of Middle-Term Trajectory Generation Unit 72]

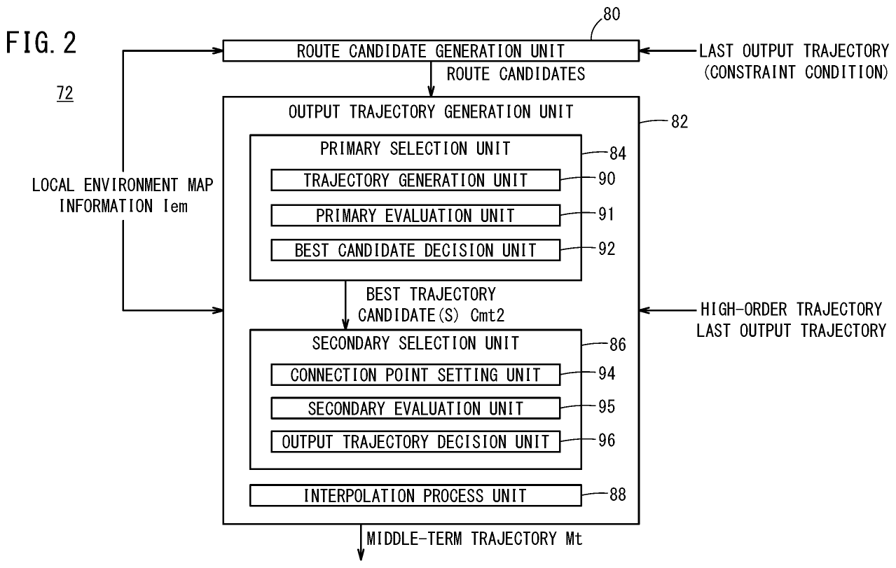

The vehicle control device 10 according to this embodiment is configured as above. Subsequently, a configuration and an operation of the middle-term trajectory generation unit 72 are described in detail with reference to FIG. 2 to FIG. 12.

### <Function Block Diagram of Middle-Term Trajectory Generation Unit 72>

FIG. 2 is a function block diagram of the middle-term trajectory generation unit 72 illustrated in FIG. 1. The middle-term trajectory generation unit 72 includes a route candidate generation unit 80 that generates route candidates, and an output trajectory generation unit 82 that selects a desired route from the route candidates and generates an output trajectory (here, middle-term trajectory Mt).

The route candidate generation unit 80 generates candidates of the point sequence (x, y) where the vehicle 120 should pass (that is, route candidates) by using the local environment map information Iem and the last output trajectory (specifically, middle-term trajectory Mt that is generated the most recently).

The output trajectory generation unit 82 generates the latest middle-term trajectory Mt by using the local environment map information Iem, a high-order trajectory (specifically, long-term trajectory Lt) and the last output trajectory (the most recent middle-term trajectory Mt), in addition to the route candidate generated by the route candidate generation unit 80. The output trajectory generation unit 82 includes a primary selection unit 84 that performs a primary selection process to be described below, a secondary selection unit 86 that performs a secondary selection process to be described below, and an interpolation process unit 88 that interpolates any point sequence by an interpolation curve.

### <Configuration of Primary Selection Unit 84>

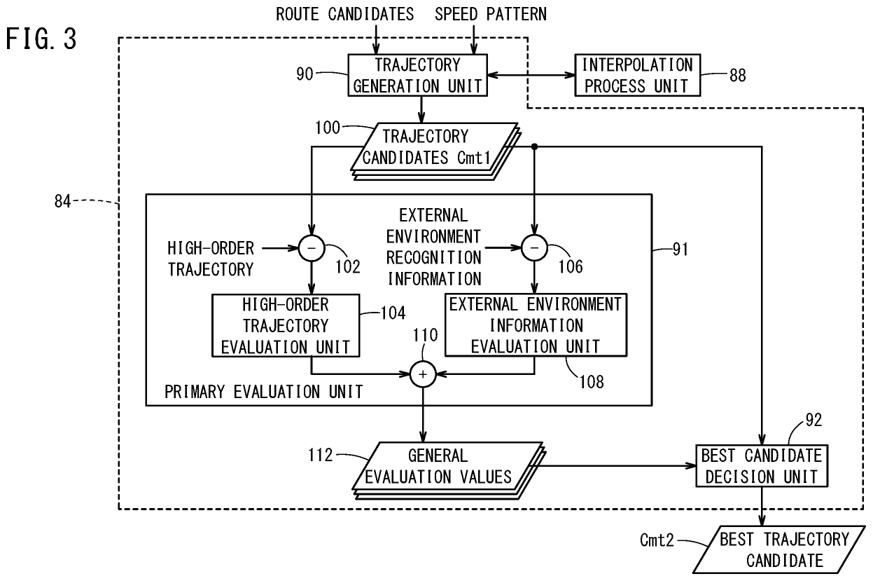

FIG. 3 is a function block diagram of the primary selection unit 84 illustrated in FIG. 2. The primary selection unit 84 performs the primary selection process for a plurality of trajectory candidates Cmt1. Specifically, the primary selection unit 84 includes a trajectory generation unit 90, a primary evaluation unit 91, and a best candidate decision unit 92.

The trajectory generation unit 90 combines a desired speed pattern (time series pattern of target speed) with each route candidate so as to generate a set of the trajectory candidates Cmt1 (hereinafter, also referred to as a trajectory candidate group 100).

The primary evaluation unit 91 performs primary evaluation for the trajectory candidate group 100 so as to calculate a general evaluation value 112 in each of the trajectory candidates Cmt1. Specifically, the primary evaluation unit 91 includes a subtractor 102 that calculates a deviation (first feature quantity) between the trajectory candidate Cmt1 and the high-order layer trajectory (long-term trajectory Lt), a high-order trajectory evaluation unit 104 that converts the first feature quantity into an evaluation value on the basis of a predetermined evaluation criterion, a subtractor 106 that calculates a deviation (second feature quantity) between the trajectory candidate Cmt1 and the external environment recognition information Ipr, an external environment information evaluation unit 108 that converts the second feature quantity into the evaluation value on the basis of a predetermined evaluation criterion, and an adder 110 that calculates the general evaluation value 112 by adding up the evaluation value for each evaluation item.

For example, the high-order trajectory evaluation unit 104 may acquire the evaluation value in consideration of approximation in each component (x, y, θz, vs, va, δst) between the trajectory candidate Cmt1 and the long-term trajectory Lt. Specifically, the evaluation criterion can be set so that as a positional deviation (Δy) in the lateral direction is smaller, the evaluation value is higher, and as this positional deviation is larger, the evaluation value is lower.

For example, the external environment information evaluation unit 108 may acquire the evaluation value in consideration of (1) approximation of the direction of the lane mark and the attitude angle θz expressed by the trajectory candidate Cmt1, (2) a possibility of interference by the obstacle for the vehicle 120, or the like. In the former case, the evaluation criterion can be set so that the evaluation value is higher as the directions are closer to each other, and the evaluation value is lower as the directions are more different. In the latter case, the evaluation criterion can be set so that as the possibility of the interference is lower, the evaluation value is higher, and as the possibility of the interference is higher, the evaluation value is lower.

The best candidate decision unit 92 selects one or a plurality of trajectory candidates Cmt1 from the trajectory candidate group 100, and decides the best trajectory candidate Cmt2. Specifically, the best candidate decision unit 92 refers to the general evaluation values 112 that are acquired in the primary evaluation unit 91, and selects the trajectory candidates Cmt1 in descending order of superiority of the evaluation result (descending order of evaluation value).

<Decision about Trajectory Candidate Cmt1>

FIG. 4 is a first schematic diagram that illustrates a positional relation between the vehicle 120 on a virtual space 122 and the point sequence that specifies the trajectory candidate Cmt1. This virtual space 122 is a plane space that is defined by a local coordinate system whose origin O is a point (hereinafter, a neighboring point 126) that is near to a start point 124 expressing the position of the vehicle 120.

Here, the neighboring point 126 corresponds to a point that is the nearest to the vehicle 120 among the trajectory point sequence that forms the middle-term trajectory Mt that is generated the most recently. The X-axis on the virtual space 122 corresponds to a traveling direction (that is, vehicle length direction) of the vehicle 120 that is assumed at the neighboring point 126. The Y-axis on the virtual space 122 is a coordinate axis that is orthogonal to the X-axis, and corresponds to a vehicle width direction of the vehicle 120 that is assumed at the neighboring point 126.

The point sequence that is “sparse” in this diagram expresses the position of the trajectory candidate Cmt1, and includes one start point 124, two via-points 128, 129, and one end point 130. The start point 124 corresponds to the current position of the vehicle 120. The via-point 128 expresses one of positions which the vehicle 120 at the neighboring point 126 can reach in three seconds. The via-point 129 expresses one of positions which the vehicle 120 at the neighboring point 126 can reach in five seconds. The end point 130 expresses one of positions which the vehicle 120 at the neighboring point 126 can reach in seven seconds.

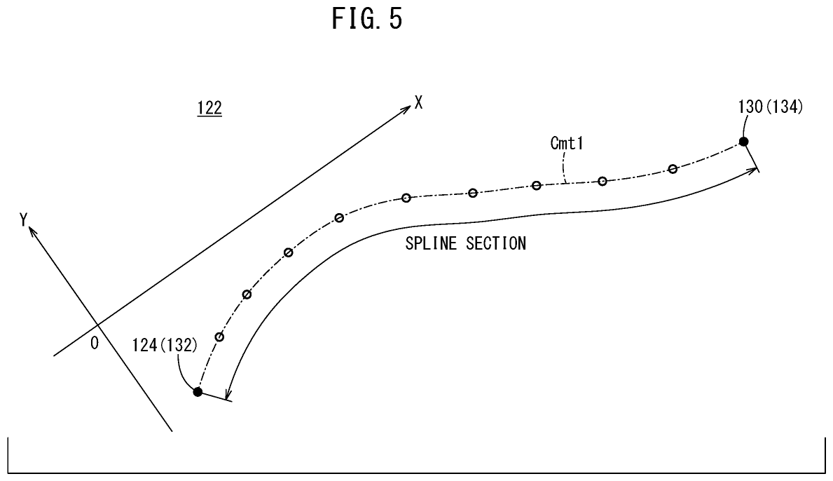

FIG. 5 is a second schematic diagram that illustrates a positional relation between the vehicle 120 on the virtual space 122 and the point sequence that specifies the trajectory candidate Cmt1. More specifically, this diagram expresses a shape (dash-dot line) of the trajectory candidate Cmt1 that is acquired by using spline interpolation for the “sparse” point sequence in FIG. 4.

In eleven points that form a “dense” point sequence, a beginning point of the trajectory candidate Cmt1 (hereinafter, trajectory beginning point 132) corresponds to the start point 124, and an end point of the trajectory candidate Cmt1 (hereinafter, a trajectory end point 134) corresponds to the end point 130. Note that the entire section from the trajectory beginning point 132 to the trajectory end point 134 is interpolated by a spline curve.

### <Configuration of Secondary Selection Unit 86>

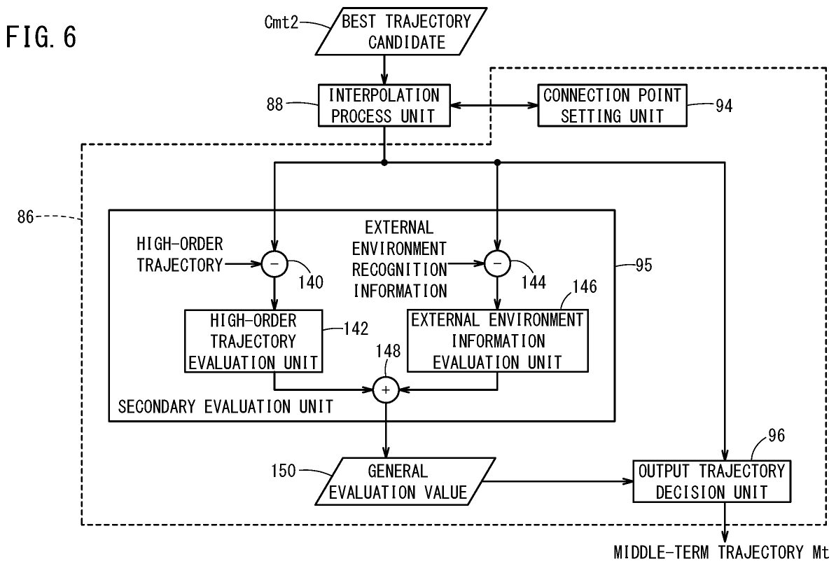

FIG. 6 is a function block diagram of the secondary selection unit 86 illustrated in FIG. 2. The secondary selection unit 86 performs the secondary selection process for a part of the trajectory candidate group 100 for which the primary evaluation has been performed (one or a plurality of best trajectory candidates Cmt2). Specifically, the secondary selection unit 86 includes a connection point setting unit 94, a secondary evaluation unit 95, and an output trajectory decision unit 96.

Similarly to the primary evaluation unit 91 (FIG. 3), the secondary evaluation unit 95 includes a subtractor 140 that calculates the deviation (first feature quantity) between the trajectory candidate Cmt1 and the high-order trajectory (long-term trajectory Lt), a high-order trajectory evaluation unit 142 that converts the first feature quantity into the evaluation value on the basis of the predetermined evaluation criterion, a subtractor 144 that calculates the deviation (second feature quantity) between the trajectory candidate Cmt1 and the external environment recognition information Ipr, an external environment information evaluation unit 146 that converts the second feature quantity into the evaluation value on the basis of the predetermined evaluation criterion, and an adder 148 that calculates a general evaluation value 150 by adding up the evaluation value for each evaluation item.

### <Operation of Secondary Selection Unit 86>

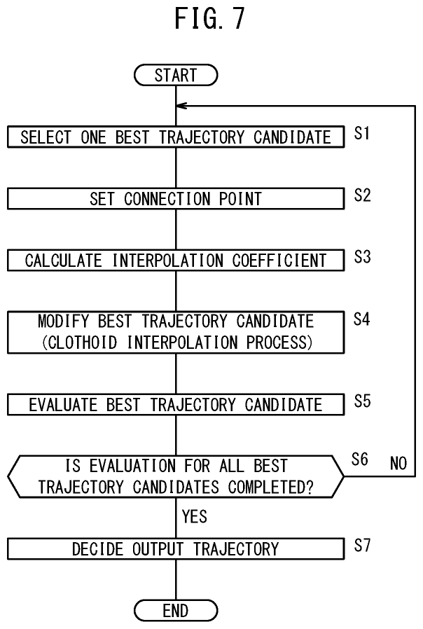

Subsequently, an operation of the secondary selection unit 86 illustrated in FIG. 6 is described in detail with reference to a flowchart in FIG. 7 and FIG. 8 to FIG. 11.

In step S1 in FIG. 7, the output trajectory generation unit 82 selects, from one or the plurality of best trajectory candidates Cmt2, one best trajectory candidate Cmt2 for which secondary evaluation has not been performed yet. Then, the interpolation process unit 88 acquires the best trajectory candidate Cmt2 that is selected by the primary selection unit 84.

In step S2 in FIG. 7, the connection point setting unit 94 sets a connection point 136 that exists between the start point 124 and the end point 130 of the point sequence that expresses the position of the best trajectory candidate Cmt2 (travel trajectory) that is selected in step S1.

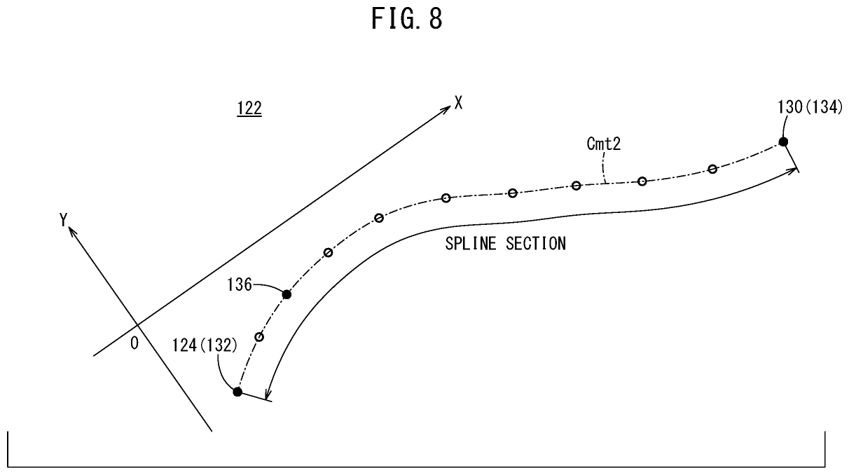

As illustrated in FIG. 8, in the eleven points that form the “dense” point sequence, it is assumed that the third point from the start point 124 (trajectory beginning point 132) is set as the connection point 136. Note that the connection point 136 may be an intermediate point on the spline curve (except for the start point 124 and the end point 130), and the curvature (κ) and the rate of change of the curvature (κ′) may be known.

In step S3 in FIG. 7, the interpolation process unit 88 calculates an interpolation coefficient that expresses a clothoid curve (including various improvement models) that satisfies a particular border condition. As a method for calculating the interpolation coefficient, an example of triple clothoid curve is hereinafter described in detail.

It is assumed that the coordinates of the trajectory beginning point 132 corresponding to the start point of the clothoid curve are (xₛ, yₛ) and the coordinates of the connection point 136 corresponding to the end point of the clothoid curve are (x_{g}, y_{g}). Then, coordinates (x, y) on the clothoid curve can be acquired by the following Expressions (1) using the coordinate values (xₛ, yₛ).

$$\begin{matrix}[ Expressions 1 ] & \\ \{ \begin{matrix}x ( S ) = {x}_{S} = L {\int }_{0}^{S} cos θ ( S ) dS \\ y ( S ) = {y}_{S} + L {\int }_{0}^{S} sin θ ( S ) dS\end{matrix} & ( 1 )\end{matrix}$$

Here, the parameter S corresponds to the length of a curve that is normalized so that a possible value is in the range of [0, 1] (hereinafter, referred to as “normalized length S”). That is, the coordinates of the trajectory beginning point 132 correspond to (x(0), y(0)), and the coordinates of the connection point 136 correspond to (x(1), y(1)).

In a case of the triple clothoid curve, the attitude angle θ(S) in Expressions (1) can be obtained by the following Expression (2) and Expression (3). Note that S₁ and S₂ are positive numbers that satisfy 0<S₁<S₂<1 (for example, fixed value; S₁=⅓, S₂=⅔).

$$\begin{matrix}[ Expression 2 ] & \\ \{ \begin{matrix}{a}_{10} + {a}_{11} S + {a}_{12} {S}^{2} & ( 0 \leq S \leq {S}_{1} ) \\ {a}_{20} + {a}_{21} S + {a}_{22} {S}^{2} & ( {S}_{1} \leq S \leq {S}_{2} ) \\ {a}_{30} + {a}_{31} S + {a}_{32} {S}^{2} & ( {S}_{2} \leq S \leq 1 )\end{matrix} & ( 2 ) \\ [ Expression 3 ] & \\ ( \begin{matrix}{a}_{10} & {a}_{11} & {a}_{12} \\ {a}_{20} & {a}_{21} & {a}_{22} \\ {a}_{30} & {a}_{31} & {a}_{32}\end{matrix} ) = ( \begin{matrix}{θ}_{0} & {κ}_{0} L & \frac{1}{2} {κ}_{0}^{′} {L}^{2} \\ {θ}_{1} & {κ}_{1} L & \frac{1}{2} {κ}_{1}^{′} {L}^{2} \\ {θ}_{2} & {κ}_{2} L & \frac{1}{2} {κ}_{2}^{′} {L}^{2}\end{matrix} ) & ( 3 )\end{matrix}$$

Here, the attitude angle intercept {θᵢ}, the curvature {κᵢ}, the rate of change of the curvature {κ′ᵢ} (i=0 to 2), and the scale variable L correspond to a total of ten interpolation coefficients that can decide the shape of the triple clothoid curve.

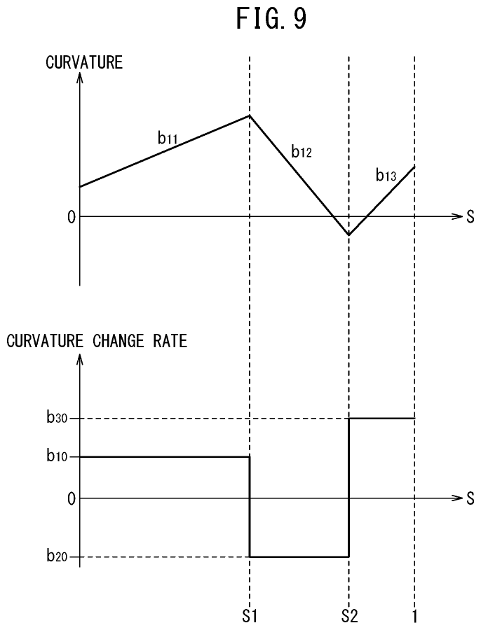

FIG. 9 is a diagram that shows the position dependency of the curvature κ and the rate of change of the curvature κ′ in the triple clothoid curve. A lateral axis of the graph indicates the normalized length S, and longitudinal axes of the graph indicate the curvature κ (upper graph) and the rate of change of the curvature κ′ (lower graph).

A curvature κ(S) can be obtained by the following Expression (4) and Expression (5) using the normalized length S. Note that if the border condition to connect adjacent strait lines in a case where S=S₁, S₂ is provided, the continuity of the curvature κ(S) can be secured.

$$\begin{matrix}[ Expression 4 ] & \\ κ ( S ) = \{ \begin{matrix}{b}_{10} + {b}_{11} S & ( 0 \leq S \leq {S}_{1} ) \\ {b}_{20} + {b}_{21} S & ( {S}_{1} \leq S \leq {S}_{2} ) \\ {b}_{30} + {b}_{31} S & ( {S}_{2} \leq S \leq 1 )\end{matrix} & ( 4 ) \\ [ Expression 5 ] & \\ ( \begin{matrix}{b}_{10} & {b}_{11} \\ {b}_{20} & {b}_{21} \\ {b}_{30} & {b}_{31}\end{matrix} ) = ( \begin{matrix}{κ}_{0} & {κ}_{0}^{′} L \\ {κ}_{1} & {κ}_{1}^{′} L \\ {κ}_{2} & {κ}_{2}^{′} L\end{matrix} ) & ( 5 )\end{matrix}$$

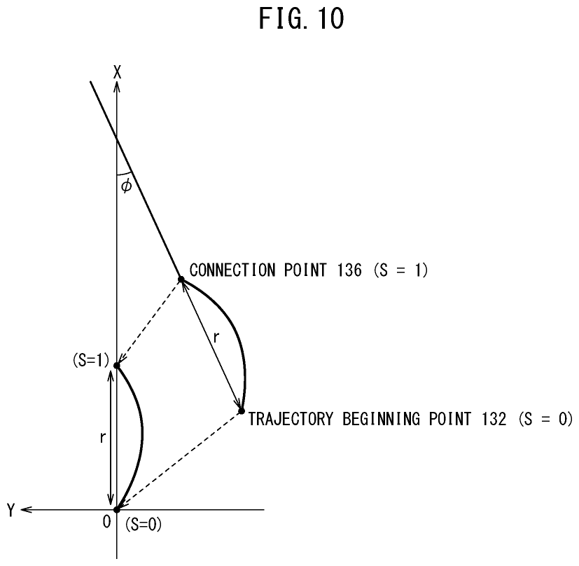

As illustrated in FIG. 10, by performing affine transformation for the clothoid curve, the trajectory beginning point 132 is moved to the origin O (0, 0) and the connection point 136 is moved to (r, 0) that is one point on the X-axis. Four feature values (Δx, Δy, r, φ) that express a relative positional relation between the trajectory beginning point 132 and the connection point 136 can be obtained by the following Expressions (6).

$$\begin{matrix}[ Expressions 6 ] & \\ Δ x = {x}_{g} - {x}_{s} \\ Δ y = {y}_{g} - {y}_{s} \\ r = \sqrt{Δ {x}^{2} + Δ {y}^{2}} \\ ϕ = arctan ( \frac{Δ y}{Δ x} ) & ( 6 )\end{matrix}$$

Here, Δx corresponds to a positional deviation on the X-axis of the connection point 136 with respect to the trajectory beginning point 132, Δy corresponds to a positional deviation on the Y-axis of the connection point 136 with respect to the trajectory beginning point 132, r corresponds to a distance between the trajectory beginning point 132 and the connection point 136, and φ corresponds to an angle between a straight line that connects the trajectory beginning point 132 and the connection point 136, and the X-axis.

The coordinates (x, y) on the clothoid curve after the affine transformation can be obtained by the following Expressions (7) using the normalized length S.

$$\begin{matrix}[ Expressions 7 ] & \\ \{ \begin{matrix}x ( S ) = L {\int }_{0}^{S} cos θ ( S ) dS \\ y ( S ) = L {\int }_{0}^{S} sin θ ( S ) dS\end{matrix} & ( 7 )\end{matrix}$$

In the case of the triple clothoid curve, the attitude angle θ(S) in Expressions (7) can be obtained by the following Expression (8) to Expressions (10). Note that S₁ and S₂ are positive numbers that satisfy 0<S₁<S₂<1, and coincide with the values in Expression (2).

$$\begin{matrix}[ Expression 8 ] & \\ θ ( S ) = \{ \begin{matrix}{a}_{10} + {a}_{11} + {a}_{12} {S}^{2} & ( 0 \leq S \leq {S}_{1} ) \\ {a}_{20} + {a}_{21} ( S - {S}_{1} ) + {{a}_{22} ( S - {S}_{1} )}^{2} & ( {S}_{1} \leq S \leq {S}_{2} ) \\ {a}_{30} + {a}_{31} ( S - {S}_{2} ) + {{a}_{32} ( S - {S}_{2} )}^{2} & ( {S}_{2} \leq S \leq 1 )\end{matrix} & ( 8 ) \\ [ Expression 9 ] & \\ ( \begin{matrix}{a}_{10} & {a}_{11} & {a}_{12} \\ {a}_{20} & {a}_{21} & {a}_{22} \\ {a}_{30} & {a}_{31} & {a}_{32}\end{matrix} ) = ( \begin{matrix}Δ {ϕ}_{0} & {κ}_{0} L & \frac{1}{2} {κ}_{0}^{′} {L}^{2} \\ Δ {ϕ}_{1} & {κ}_{1} L & \frac{1}{2} {κ}_{1}^{′} {L}^{2} \\ Δ {ϕ}_{2} & {κ}_{2} L & \frac{1}{2} {κ}_{2}^{′} {L}^{2}\end{matrix} ) & ( 9 ) \\ [ Expressions 10 ] & \\ {Δϕ}_{0} = {θ}_{0} - ϕ \\ {Δϕ}_{1} = {θ}_{1} - ϕ \\ {Δϕ}_{2} = {θ}_{2} - ϕ & ( 10 )\end{matrix}$$

The curvature κ(S) can be obtained by the following Expression (11) using the normalized length S. Here, a coefficient {bᵢⱼ} coincides with the coefficient in Expression (5) as above.

$$\begin{matrix}[ Expression 11 ] & \\ κ ( S ) = \{ \begin{matrix}{b}_{10} + {b}_{11} S & ( 0 \leq S \leq {S}_{1} ) \\ {b}_{20} + {b}_{21} ( S - {S}_{1} ) & ( {S}_{1} \leq S \leq {S}_{2} ) \\ {b}_{30} + {b}_{31} ( S - {S}_{2} ) & ( {S}_{2} \leq S \leq 1 )\end{matrix} & ( 11 )\end{matrix}$$

The border condition for the position on the clothoid curve is expressed in the following Expressions (12). If this border condition is provided, the continuity of the position around S=0 (trajectory beginning point 132) and S=1 (connection point 136) can be secured simultaneously.

$$\begin{matrix}[ Expressions 12 ] & \\ \{ \begin{matrix}r = L {\int }_{0}^{S} cos θ ( S ) dS \\ 0 = {\int }_{0}^{S} sin θ ( S ) dS\end{matrix} & ( 12 )\end{matrix}$$

The border condition regarding the curvature on the clothoid curve is expressed by the following Expressions (13). If this border condition is provided, the continuity of the curvature around S=0 (trajectory beginning point 132), S=S₁ (first inflection point), S=S₂ (second inflection point), and S=1 (connection point 136) can be secured simultaneously.

$$\begin{matrix}[ Expressions 13 ] & \\ \{ \begin{matrix}{Δϕ}_{0} = {θ}_{s} - ϕ \\ {Δϕ}_{1} = {Δϕ}_{0} + {κ}_{0} {LS}_{1} + \frac{1}{2} {κ}_{0}^{′} {L}^{2} {S}_{1}^{2} \\ {Δϕ}_{2} = {Δϕ}_{1} + {κ}_{1} L ( {S}_{2} - {S}_{1} ) + \frac{1}{2} {κ}_{1}^{′} {{L}^{2} ( {S}_{2} - {S}_{1} )}^{2} \\ {Δϕ}_{2} + {κ}_{1} L ( 1 - {S}_{2} ) + \frac{1}{2} {κ}_{1}^{′} {{L}^{2} ( 1 - {S}_{2} )}^{2} = {θ}_{g} - ϕ\end{matrix} & ( 13 )\end{matrix}$$

The border condition regarding the rate of change of the curvature on the clothoid curve is expressed by the following Expressions (14). If this border condition is provided, the continuity of the rate of change of the curvature around S=0 (trajectory beginning point 132) and S=1 (connection point 136) can be secured simultaneously.

$$\begin{matrix}[ Expressions 14 ] & \\ \{ \begin{matrix}{κ}_{0} = {κ}_{S} \\ {κ}_{1} = {κ}_{0} + {κ}_{0}^{′} {S}_{1} \\ {κ}_{2} = {κ}_{1} + {κ}_{1}^{′} ( {S}_{2} - {S}_{1} ) \\ {κ}_{2} + {κ}_{2}^{′} ( 1 - {S}_{2} ) = {κ}_{g}\end{matrix} & ( 14 )\end{matrix}$$

The interpolation process unit 88 calculates ten interpolation coefficients that are unknown by solving a total of ten nonlinear simultaneous equations expressed in Expressions (12) to Expressions (14). To solve the nonlinear simultaneous equations, a known method including Newton-Raphson method may be used.

Note that the method for calculating the interpolation coefficient is not limited to the above example, and may include another constraint condition different from the above border condition, for example. In addition, by treating S₁ and S₂ as not fixed values but one kind of interpolate coefficient, the redundancy (degree of freedom) for a solution may be provided.

In step S4 in FIG. 7, the interpolation process unit 88 performs an interpolation process by the clothoid curve expressed in Expressions (1) to Expression (5) as described above using the interpolation coefficient that is calculated in step S3. Specifically, the interpolation process unit 88 modifies a part of the best trajectory candidate Cmt2 by replacing a section from the trajectory beginning point 132 to the connection point 136.

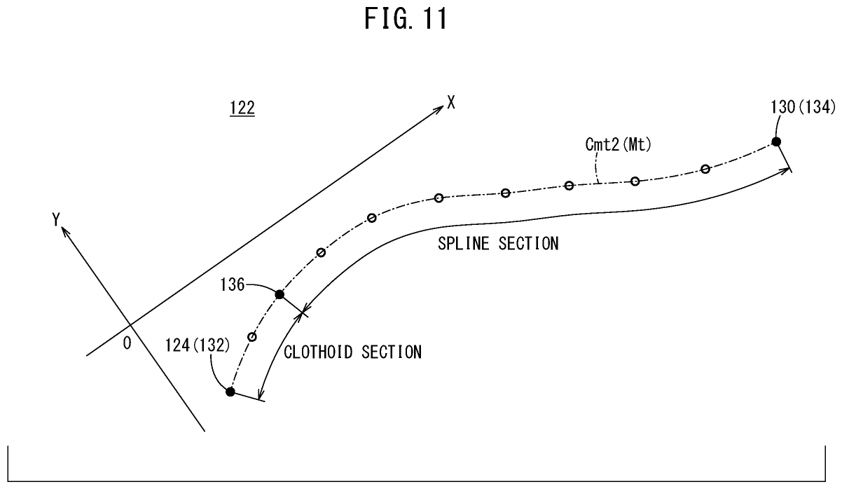

As illustrated in FIG. 11, the best trajectory candidate Cmt2 includes “a clothoid section” from the start point 124 (trajectory beginning point 132) to the connection point 136, and “a spline section” from the connection point 136 to the end point 130 (trajectory end point 134).

In “the spline section” that is interpolated by using the spline curve, the smoothness of the trajectory is secured. In addition, in “the clothoid section” that is interpolated by using the clothoid curve, the smoothness of the trajectory is secured. Furthermore, since this clothoid curve satisfies the border condition regarding the trajectory beginning point 132 and the connection point 136 (that is, border condition that guarantees continuity of position, curvature, and rate of change of curvature), the smoothness of the trajectory around the trajectory beginning point 132 and the connection point 136 is secured.

In step S5 in FIG. 7, the secondary evaluation unit 95 performs the secondary evaluation for the best trajectory candidate Cmt2 that is modified in step S4. Here, the secondary evaluation unit 95 may perform the same evaluation (secondary evaluation) as the primary evaluation, or the secondary evaluation in which at least one of the calculation quantity, a calculation time, and the number of items is different from that of the primary evaluation.

In the latter case, for example, the primary evaluation unit 91 may perform the primary evaluation that does not include an evaluation item regarding the smoothness of the trajectory around the trajectory beginning point 132, and the secondary evaluation unit 95 may perform the secondary evaluation that includes the evaluation item regarding the smoothness of the trajectory around the trajectory beginning point 132. The calculation time to evaluate each travel trajectory can be drastically reduced by omitting the evaluation of the smoothness of the trajectory for the tentative candidates (primary evaluation) and performing the evaluation of the smoothness of the trajectory for the final candidates (secondary evaluation).

Moreover, the interpolation process unit 88 may interpolate the section from the connection point 136 to the end point 130 (trajectory end point 134) by a polynomial expression interpolation curve including, in addition to the above spline curve, a B-spline curve, a Lagrange curve, and a Bezier curve. If the section (section from connection point 136 to end point 130) in which the smoothness of the trajectory can be secured easily is interpolated by the polynomial expression interpolation curve whose calculation time is less than that of the clothoid curve, the calculation time of the interpolation process can be further reduced.

Furthermore, the primary evaluation unit 91 may perform the primary evaluation for each trajectory candidate Cmt1 (travel trajectory) in which the section from the trajectory beginning point 132 to the connection point 136 is interpolated by the polynomial expression interpolation curve (for example, spline curve), and the secondary evaluation unit 95 may perform the secondary evaluation for each best trajectory candidate Cmt2 (travel trajectory) in which the section from the trajectory beginning point 132 to the connection point 136 is interpolated by the clothoid curve. Accordingly, the execution of the interpolation process by the clothoid curve for the candidates that are excluded in the primary evaluation can be omitted. Thus, the calculation time to generate each travel trajectory can be drastically reduced.

In step S6 in FIG. 7, the output trajectory generation unit 82 determines whether the secondary evaluation for all the best trajectory candidates Cmt2 is completed. If it is determined that the secondary evaluation is not completed yet (step S6: NO), the process returns to step S1 and steps S1 to S6 are successively repeated until the secondary evaluation is completed. On the other hand, if it is determined that the secondary evaluation is completed (step S6: YES), the process advances to the next step (S7).

In step S7 in FIG. 7, the output trajectory decision unit 96 selects one best trajectory candidate Cmt2 from one or the plurality of best trajectory candidates Cmt2, and decides the middle-term trajectory Mt as the output trajectory. Specifically, the output trajectory decision unit 96 refers to the general evaluation value 150 that is acquired by the secondary evaluation unit 95, and selects the best trajectory candidate Cmt2 whose evaluation result is the best (whose evaluation value is maximum).

<Case where Start Point 124 and Trajectory Beginning Point 132 are Different>

As described above, the operation of the secondary selection unit 86 illustrated in FIG. 6 ends. In the above example of the operation, it is assumed that the trajectory beginning point 132 coincides with the start point 124; however, the trajectory beginning point 132 may be different from the start point 124.

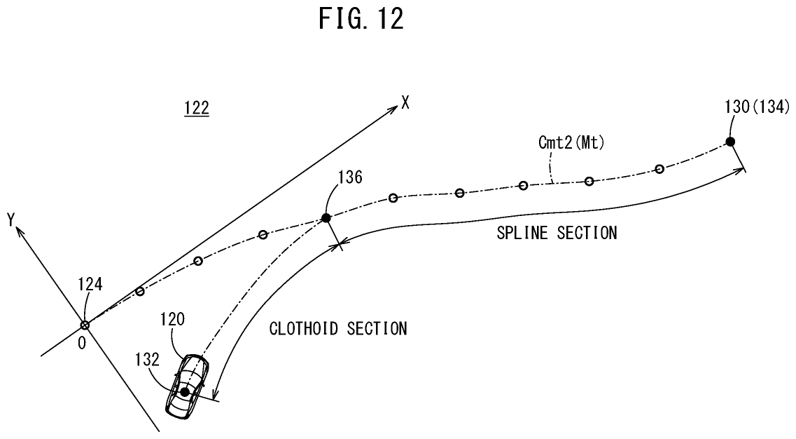

As illustrated in FIG. 12, the best trajectory candidate Cmt2 includes “the clothoid section” from the trajectory beginning point 132 to the connection point 136, and “the spline section” from the connection point 136 to the end point 130 (trajectory end point 134). Here, after the entire section from the start point 124 to the end point 130 is interpolated by the spline curve, “the clothoid section” is extrapolated instead of “the spline section”. Even in this configuration, the smoothness of the trajectory is secured similarly to the case in FIG. 11.

### [Effect of Vehicle Control Device 10]

As described above, the vehicle control device 10 is [1] the device configured to successively generate the travel trajectory of the vehicle 120 and control the vehicle 120 on the basis of the travel trajectory, the vehicle control device 10 including: [2] the connection point setting unit 94 configured to set the connection point 136 that exists between the start point 124 and the end point 130 of the point sequence expressing the position of at least a part of the best trajectory candidate Cmt2 (travel trajectory); and [3] the interpolation process unit 88 configured to specify the position of the best trajectory candidate Cmt2 by interpolating the section from the trajectory beginning point 132 of the best trajectory candidate Cmt2 to the connection point 136 that is set by the clothoid curve that satisfies the border condition regarding the trajectory beginning point 132 and the connection point 136.

In addition, a vehicle control method using the vehicle control device 10 is [1] a method for successively generating the travel trajectory of the vehicle 120 and controlling the vehicle 120 on the basis of the travel trajectory, and causing one or a plurality of computers to perform [2] a setting step (S2) of setting the connection point 136 that exists between the start point 124 and the end point 130 of the point sequence expressing the position of at least a part of the best trajectory candidate Cmt2 (travel trajectory), and [3] an interpolation step (S4) of specifying the position of the best trajectory candidate Cmt2 by interpolating the section from the trajectory beginning point 132 of the best trajectory candidate Cmt2 to the connection point 136 that is set by the clothoid curve that satisfies the border condition regarding the trajectory beginning point 132 and the connection point 136.

In this manner, the section from the trajectory beginning point 132 to the connection point 136 is interpolated by the clothoid curve that satisfies the border condition regarding the trajectory beginning point 132 and the connection point 136. Thus, the entire section of the trajectory that includes the trajectory beginning point 132 and the connection point 136 becomes smooth regardless of the shape of the interpolation curve in the section from the connection point 136 to the end point 130 of the point sequence. Therefore, the smoothness of the trajectory around the trajectory beginning point 132 can be secured while the calculation time of the interpolation process is reduced.

### [Supplement]

The present invention is not limited to the embodiment above, and can be changed freely within the range not departing from the concept of the present invention.

1. A vehicle control device configured to successively generate a travel trajectory of a vehicle and control the vehicle on a basis of the travel trajectory, the vehicle control device comprising:
a connection point setting unit configured to set a connection point that exists between a start point and an end point of a point sequence expressing a position of at least a part of the travel trajectory; and
an interpolation process unit configured to specify the position of the travel trajectory by interpolating a section from a trajectory beginning point of the travel trajectory to the connection point that is set by the connection point setting unit, by a clothoid curve that satisfies a border condition regarding the trajectory beginning point and the connection point.

2. The vehicle control device according to claim 1, wherein the interpolation process unit is configured to interpolate a section from the connection point to the end point, by a polynomial expression interpolation curve.

3. The vehicle control device according to claim 2 further comprising:
a primary evaluation unit configured to perform a primary evaluation for a candidate group of the travel trajectory; and
a secondary evaluation unit configured to perform a secondary evaluation for a part of the candidate group of the travel trajectory for which the primary evaluation has been performed by the primary evaluation unit, wherein:
the primary evaluation unit is configured to perform the primary evaluation for each travel trajectory in which the section from the trajectory beginning point to the connection point is interpolated by the polynomial expression interpolation curve; and
the secondary evaluation unit is configured to perform the secondary evaluation for each travel trajectory in which the section from the trajectory beginning point to the connection point is interpolated by the clothoid curve.

4. The vehicle control device according to claim 3, wherein the secondary evaluation unit is configured to perform the secondary evaluation in which at least one of calculation quantity, a calculation time, and number of items is different from that of the primary evaluation.

5. The vehicle control device according to claim 4, wherein:
the primary evaluation unit is configured to perform the primary evaluation that does not include an evaluation item regarding smoothness of the trajectory around the trajectory beginning point; and
the secondary evaluation unit is configured to perform the secondary evaluation that includes the evaluation item regarding the smoothness of the trajectory around the trajectory beginning point.
